(19) United States
(12) Patent Application Publication
(10) Pub. No.: US 2016/0125522 A1
(43) Pub. Date: May 5, 2016

(54) AUTOMATIC ACCOUNT LOCKOUT

(71) Applicants: Eric S. Tang, San Francisco, CA (US); Om Dixon, San Francisco, CA (US)

(72) Inventors: Eric S. Tang, San Francisco, CA (US); Om Dixon, San Francisco, CA (US)

(73) Assignee: Wells Fargo Bank, N.A., Charlotte, NC (US)

(21) Appl. No.: 14/531,640

(22) Filed: Nov. 3, 2014

(51) Int. Cl. G06Q 40/00

(52) U.S. Cl. CPC G06Q 40/00

(57) ABSTRACT

Systems and methods of automatic lockout of an online account are discussed. One example method can comprise identifying out of pattern login behavior on the account. The out of pattern behavior can include one or more interactions wherein at least one of an IP address, a device identification, or a location associated with the one or more interactions that does not match past interactions. The method can also include determining that fraud/unauthorized money movement has occurred in the account, and automatically logging into the customer account with incorrect credentials a sufficient number of times to trigger a lockout from the account. Additionally, the method can include receiving, at a financial institution associated with the account, at least one form of authentication from a customer associated with the account to verify an identity of the customer, and directing the customer to change login credentials on the account.

### BACKGROUND

Online banking provides customers with the ability to interact with their bank on their own schedule, providing convenient access to a range of banking services. However, the ability to potentially access a customer's accounts from anywhere an Internet connection is available makes online banking a frequent and potentially lucrative target for hackers, fraudsters, etc.

A critical situation can arise when a bank believes a customer's online banking login credentials may have been compromised, a situation referred to as ‘automated validation,’ which leverages external data, available primarily via third party data breaches (e.g., the Target data breach, etc.), to discover valid login credentials on other sites, such as the bank's site, via automated scripting. Valid credentials are sorted, grouped and subsequently sold by the data brokers to fraudsters who eventually attempt to defraud customers or cause other problems based on the data they collect.

Fraudulent actions may include actions for an account takeover (ATO), falsifying or misrepresenting information related to account ownership, misrepresentation of assets, misrepresentation of a relationship, misrepresentation of use of an account, misrepresenting a legitimate use or need for information or actions requested, identity theft, identity fraud, fraudulent application for financial instrument (e.g., credit card), etc.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of automatic lockout of an online account. One example method can comprise identifying out of pattern login behavior on the account. The out of pattern behavior can include one or more interactions wherein at least one of an IP address, a device identification, or a location associated with the one or more interactions that does not match past interactions. The method can also include determining that fraud/unauthorized money movement has occurred in the account, and automatically logging into the customer account with incorrect credentials a sufficient number of times to trigger a lockout from the account. Additionally, the method can include receiving, at a financial institution associated with the account, at least one form of authentication from a customer associated with the account to verify an identity of the customer, and directing the customer to change login credentials on the account.

In another aspect, the subject innovation can comprise a system that can facilitate automatic lockout of an online account. In aspects of the subject innovation, one example system can include an account lock component that, based on a detected fraud risk, causes a password lockout of an online account via one or more incorrect login attempts to the online account, and an authentication component that determines one or more conditions for authentication of a customer associated with the online account, wherein the authentication component reactivates the online account upon the one or conditions being met.

In other aspects, the subject innovation can comprise further systems and methods that can facilitate automatic lockout of an online account. One example method can comprise the act of triggering a password lockout of an online account by automatically attempting one or more incorrect logins to the online account. The triggering the password lockout can be based on a fraud risk associated with the online account. Additionally, such an example method can comprise the acts of receiving authentication from a customer associated with the online account and reactivating the online account.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates a system that can facilitate automatic lockout of an online account (e.g., customer account at a bank, etc.) in response to a detected fraud risk, in accordance with aspects of the subject innovation.

FIG. 2 illustrates a method that can facilitate automatic lockout of an online account (e.g., customer account at a bank, etc.) in response to a detected fraud risk, in accordance with aspects of the subject innovation.

FIG. 3 illustrates a computer-readable medium or computer-readable device comprising processor-executable instructions configured to embody one or more of the provisions set forth herein, according to some embodiments.

FIG. 4 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

In various aspects, the subject innovation relates to systems and methods that can facilitate automatic lockout of an online account associated with a customer in response to potential or actual fraud. For example, where unauthorized money movement or fraud has occurred (or has a probability above a threshold value that it occurred or will occur, etc.), the subject innovation can automatically lock the online account. For example, the subject innovation can lock the online account by automatically triggering one or more existing account lockout protocols. In various embodiments, upon fraud being detected (or has a probability above a threshold value that it occurred or will occur, etc.), systems and methods of the subject innovation can attempt a login to the online account incorrectly a sufficient number of times to force a password lockout (e.g., three, etc.), making it more difficult for further fraud to occur. The customer associated with the online account can contact the bank to be authenticated and to have credentials changed (e.g., at least one of changing a password or a username) to prevent fraud or further fraud. For example, the customer can be prompted to contact (e.g., call, etc.) online customer service, enabling the customer to be authenticated and then directed to change their credentials.

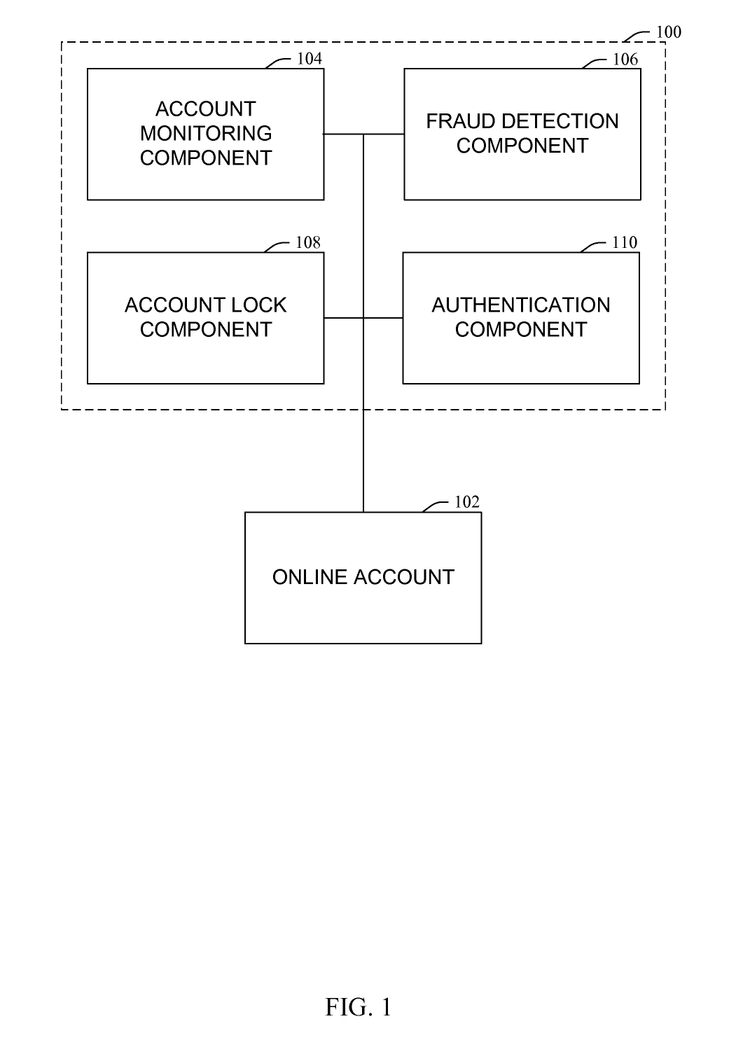

Referring initially to the drawings, FIG. 1 illustrates a system 100 that can facilitate automatic lockout of an online account 102 (e.g., customer account at a bank, etc.) in response to a detected fraud risk, in accordance with aspects of the subject innovation. System 100 can comprise an account monitoring component 104 that monitors interactions with the online account as well as associated characteristics, including, but not limited to, actual or attempted: account logins, money transfers, changes in contact information, changes in authorized parties, etc., as well as associated characteristics of the interactions, such as IP (Internet protocol) address, device ID (identification), location, etc., associated with actual or attempted account logins, etc. Based on the monitored interactions, monitoring component 104 can identify out of pattern interactions (e.g., login behavior, etc.) with the online account (e.g., IP address, device ID, location, etc. do not match past interactions (e.g., logins, etc.)).

Additionally, system 100 can comprise a fraud detection component 106. Fraud detection component 106 can analyze the monitored interactions and associated characteristics, and determine whether there is a risk of fraud, for example, whether fraud has occurred or is about to occur, or whether there is at least a threshold probability that fraud has occurred or is about to occur (e.g., based on a threshold that can be static or dynamically changed, etc.). This determination can be made based on interactions and associated characteristics discussed herein, as well as other information (e.g., account history, location-dependent factors associated with the customer or past or contemporaneous interactions, customer communications, recent events (e.g., data breaches, etc.), etc.). For example, out of pattern login behavior can be associated with a higher probability of fraud (e.g., IP address, device ID, login information, etc., that do not match prior logins or that do not accord with contemporaneous or past logins (e.g., logins or other interactions from one or more locations (even if the customer has logged in, etc. from each of those locations, etc.) within a timespan such that the customer could not have traveled between the locations in the timespan between the interactions, etc.). Additionally or alternatively, fraud detection component 106 can employ a rules-based approach such that one or more interactions or associated characteristics (or combinations thereof, e.g., a money movement request from an IP address not previously used by the customer, etc.) can be designated, either by the customer or the entity implementing the subject innovation (e.g., bank, etc.), such that upon detection of such interactions, associated characteristics, or combinations thereof, fraud detection component 106 can automatically determine that potential fraud has occurred, regardless of other factors. For example, a customer seeking additional security could designate or create a set of approved criteria or disapproved criteria (e.g., specific devices, locations, etc.), such that when an attempted interaction does not match the set of approved criteria (or does match one or more elements of the set of disapproved criteria, etc.), fraud detection component 106 can automatically determine that potential fraud has occurred, regardless of other factors.

System 100 can also include an account lock component 108. In various embodiments, in response to fraud detection component 106 determining there is a risk of fraud, account lock component 108 can lock out the online account, preventing further interaction until the customer is authenticated. In alternative embodiments, system 100 need not include monitoring component 104 or fraud detection component 106, and account lock component 108 can receive notification of a risk of fraud from any of a variety of sources external to system 100 (e.g., one or more internal or third party fraud detection systems, etc.). In various embodiments, upon receiving notification of a risk of fraud, account lock component 108 can leverage existing account security protocols to lockout the online account, such as by automatically incorrectly attempting a login of the online account a sufficient number of times (e.g., three, etc.) to force a password lockout of the online account, which makes it more difficult for fraud or further fraud to occur.

Additionally, system 100 can include an authentication component 110. Authentication component 110 can determine one or more conditions necessary for authentication of the customer and reactivation of the online account. For example, authentication component 110 can flag the online account as subject to potential fraud, requiring contact from the customer to online customer service before the account can be reactivated. Alternatively or additionally, authentication component 110 can notate the online account in an associated system, such that online customer service will be aware of the fraud risk that led to the account lockout, and require additional information to authenticate the customer. As another alternative or additional option, authentication component 110 can designate or list the account in a third party fraud monitoring application. In these or other manners, authentication component 110 can require additional security protocols to be implemented for authentication of the customer. These can include requiring answers to security questions, multi-factor authentication, requiring additional personal information for authentication, etc. Additionally, authentication component 110 can send a notification to the customer (e.g., through email, text message, etc.), indicating that the online account has been locked due to suspected fraud, and direct the customer to take steps to reactivate the account and reduce the risk of future fraud (e.g., by changing login credentials, etc.). These steps can include contacting online customer service and authenticating the customer via additional security protocols set via authentication component 110, such as security questions, etc., as described herein. After authentication, the customer can be directed (e.g., by online customer service, by authentication component 110, etc.) to change the login credentials associated with the online account. Upon changing login credentials, the online account can be unlocked (e.g., by online customer service, by authentication component 110, etc.).

In some situations, a password lockout of an account only prevents access to the account for a certain period of time, after which account access can be attempted again. In such situations, system 100 can ensure the account will remain locked out until the true customer is authenticated through any of a variety of techniques. These can include authentication component 110 flagging the account, etc., as described above. Additionally or alternatively, account lock component 108 can attempt subsequent incorrect logins at appropriate intervals to ensure the account remains inaccessible until the customer reactivates the account.

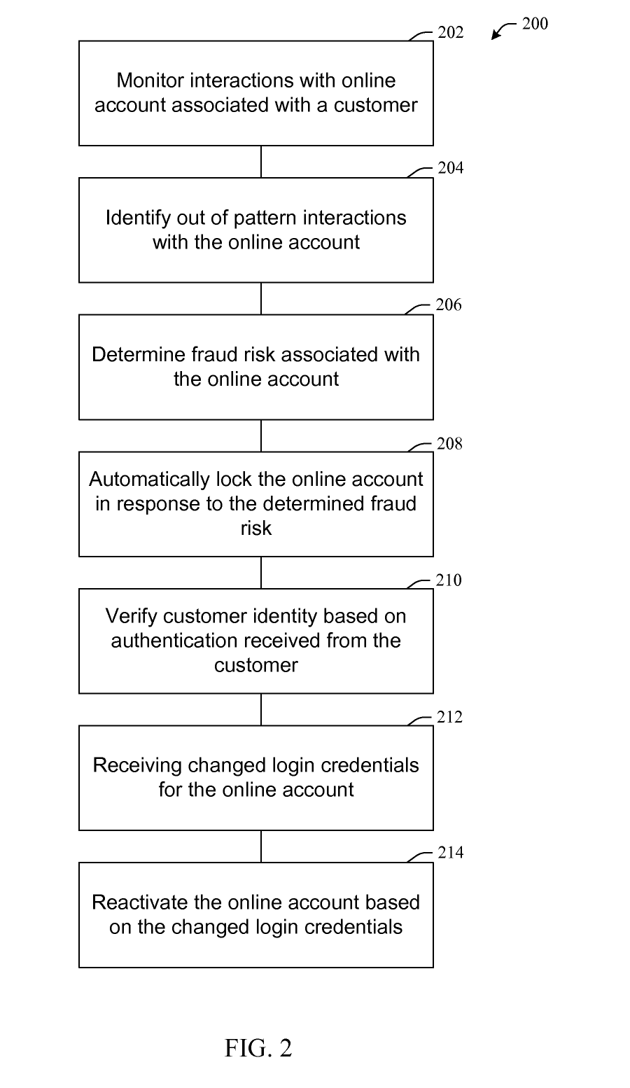

FIG. 2 illustrates a method 200 that can facilitate automatic lockout of an online account (e.g., customer account at a bank, etc.) in response to a detected fraud risk, in accordance with aspects of the subject innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Method 200 can include act 202, monitoring interactions (and associated characteristics, etc.) with an online account associated with a customer. These interactions, etc. can include those described herein, such as actual or attempted logins, funds transfers, etc. Method 200 can also include act 204, identifying one or more interactions with the online account that do not conform to prior patterns of interactions with the online account. As interactions occur, they can be compared with past and contemporaneous interactions (e.g., comparing associated characteristics, etc.) to identify interactions that do not conform to patterns of other interactions, such as by differences in IP address, device ID, location, time, etc. At act 206, method 200 can include determining a fraud risk associated with the identified one or more interactions. This fraud risk can be based on a threshold, as discussed above, or can be triggered based on the nature of the one or more interactions, also discussed above. Additionally or alternatively, method 200 can comprise an act of receiving an indication of fraud risk associated with the online account (e.g., from internal or third party fraud detection systems or methods, from the customer associated with the online account, from personnel associated with the entity employing the method, etc.), and need not include acts 202, 204, or 206.

At act 208, method 200 can include automatically locking the online account based on a fraud risk (e.g., received, determined, etc.) associated with the online account. The account can be automatically locked by leveraging existing security protocols, such as by automatically logging into the online account with incorrect credentials a sufficient number of times to trigger a lockout of the online account. Method 200 can also include act 210, wherein authentication can be received from a customer, and the customer identity can be verified based on the received authentication. At act 212, method 200 can include receiving, from the customer, changed login credentials associated with the online account. Finally, at act 214, method 200 can include reactivating the online account, which can be based on the changed login credentials.

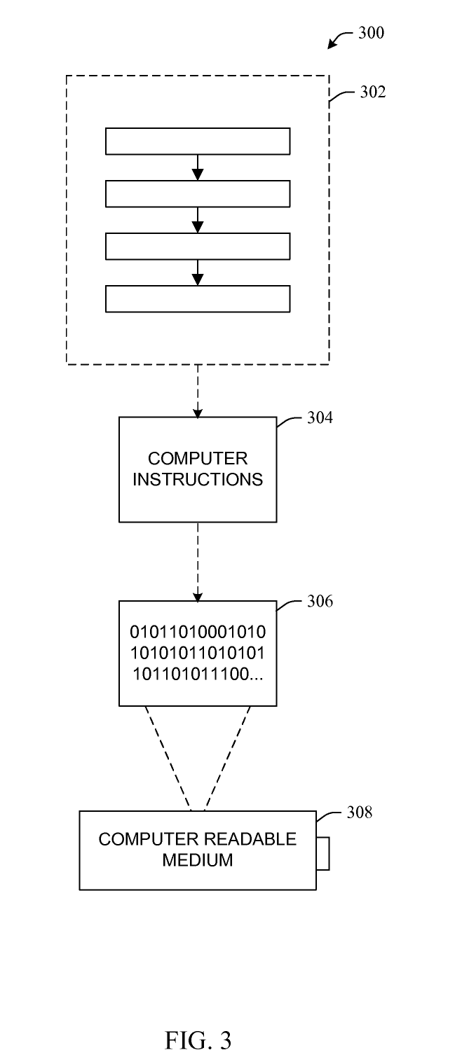

Still another embodiment can involve a computer-readable medium comprising processor-executable instructions configured to implement one or more embodiments of the techniques presented herein. An embodiment of a computer- readable medium or a computer-readable device that is devised in these ways is illustrated in FIG. 3, wherein an implementation 300 comprises a computer-readable medium 308, such as a CD-R, DVD-R, flash drive, a platter of a hard disk drive, etc., on which is encoded computer-readable data 306. This computer-readable data 306, such as binary data comprising a plurality of zero's and one's as shown in 306, in turn comprises a set of computer instructions 304 configured to operate according to one or more of the principles set forth herein. In one such embodiment 300, the processor-executable computer instructions 304 is configured to perform a method 302, such as at least a portion of one or more of the methods described in connection with embodiments disclosed herein. In another embodiment, the processor-executable instructions 304 are configured to implement a system, such as at least a portion of one or more of the systems described in connection with embodiments disclosed herein. Many such computer-readable media can be devised by those of ordinary skill in the art that are configured to operate in accordance with the techniques presented herein.

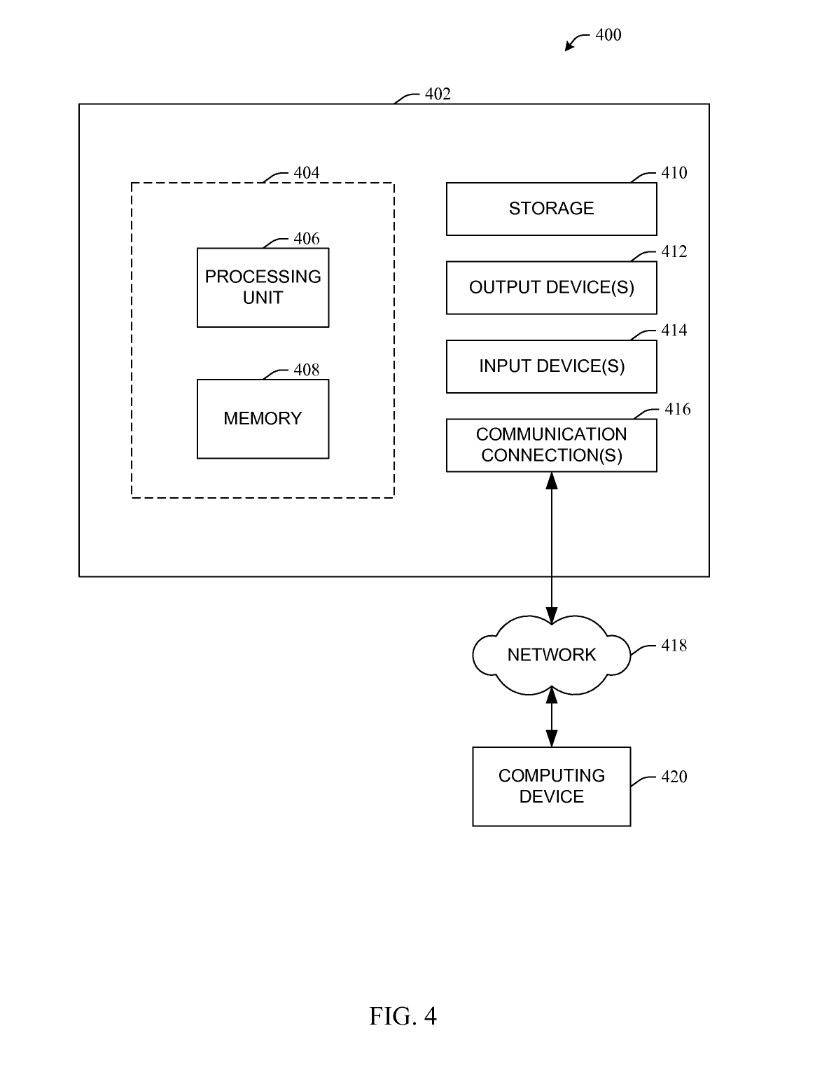

FIG. 4 and the following discussion provide a description of a suitable computing environment in which embodiments of one or more of the provisions set forth herein can be implemented. The operating environment of FIG. 4 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 4 illustrates a system 400 comprising a computing device 402 configured to implement one or more embodiments provided herein. In one configuration, computing device 402 can include at least one processing unit 406 and memory 408. Depending on the exact configuration and type of computing device, memory 408 may be volatile, such as RAM, non-volatile, such as ROM, flash memory, etc., or some combination of the two. This configuration is illustrated in FIG. 4 by dashed line 404.

In these or other embodiments, device 402 can include additional features or functionality. For example, device 402 can also include additional storage such as removable storage or non-removable storage, including, but not limited to, magnetic storage, optical storage, and the like. Such additional storage is illustrated in FIG. 4 by storage 410. In some embodiments, computer readable instructions to implement one or more embodiments provided herein are in storage 410. Storage 410 can also store other computer readable instructions to implement an operating system, an application program, and the like. Computer readable instructions can be loaded in memory 408 for execution by processing unit 406, for example.

The term “computer readable media” as used herein includes computer storage media. Computer storage media includes volatile and nonvolatile, removable and non-removable media implemented in any method or technology for storage of information such as computer readable instructions or other data. Memory 408 and storage 410 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 402. Any such computer storage media can be part of device 402.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 402 can include one or more input devices 414 such as keyboard, mouse, pen, voice input device, touch input device, infrared cameras, video input devices, or any other input device. One or more output devices 412 such as one or more displays, speakers, printers, or any other output device can also be included in device 402. The one or more input devices 414 and/or one or more output devices 412 can be connected to device 402 via a wired connection, wireless connection, or any combination thereof. In some embodiments, one or more input devices or output devices from another computing device can be used as input device(s) 414 or output device(s) 412 for computing device 402. Device 402 can also include one or more communication connections 416 that can facilitate communications with one or more other devices 420 by means of a communications network 418, which can be wired, wireless, or any combination thereof, and can include ad hoc networks, intranets, the Internet, or substantially any other communications network that can allow device 402 to communicate with at least one other computing device 420.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an account lock component that, based on a detected fraud risk, causes a password lockout of an online account via one or more incorrect login attempts to the online account; and
an authentication component that determines one or more conditions for authentication of a customer associated with the online account, wherein the authentication component reactivates the online account upon the one or conditions being met.

2. The system of claim 1, further comprising a fraud detection component that determines the fraud risk based on an analysis of one or more interactions with the online account.

3. The system of claim 2, further comprising a monitoring component that monitors the online account and identifies the one or more interactions.

4. The system of claim 3, wherein the monitoring component identifies the one or more interactions based on a comparison of characteristics of the one or more interactions with one or more prior interactions with the online account.

5. The system of claim 4, wherein the characteristics of the one or more interactions comprise one or more of an Internet protocol address, a device identification, or a location associated with the one or more interactions.

6. The system of claim 2, wherein the fraud detection component determines the fraud risk based on a probability of fraud exceeding a threshold.

7. The system of claim 2, wherein the fraud detection component determines the fraud risk based on a comparison between the one or more interactions with a set of criteria.

8. The system of claim 7, wherein the set of criteria comprises one or more user-created criteria.

9. The system of claim 7, wherein the set of criteria comprises a user-initiated change in login credentials.

10. The system of claim 1, wherein the authentication component notifies the customer of the password lockout.

11. The system of claim 1, wherein the one or more conditions comprise authentication via one or more security protocols.

12. The system of claim 1, wherein the authentication component flags the online account as subject to potential fraud.

13. A method, comprising:
triggering a password lockout of an online account by automatically attempting one or more incorrect logins to the online account, wherein the triggering the password lockout is based on a fraud risk associated with the online account;
receiving authentication from a customer associated with the online account; and
reactivating the online account.

14. The method of claim 13, further comprising directing the customer to change login credentials associated with the online account, wherein reactivating the online account comprises reactivating the online account based on the changed login credentials.

15. The method of claim 13, further comprising determining a fraud risk associated with the online account, wherein the fraud risk is determined based on an analysis of one or more interactions with the online account.

16. The method of claim 15, further comprising identifying the one or more interactions based on a comparison of characteristics of the one or more interactions with one or more prior interactions with the online account.

17. The method of claim 16, wherein the characteristics of the one or more interactions comprise one or more of an Internet protocol address, a device identification, or a location associated with the one or more interactions.

18. The method of claim 13, further comprising receiving changed login credentials associated with the online account from a customer associated with the online account, wherein reactivating the online account comprises reactivating the online account in response to receiving the changed login credentials.

19. The method of claim 18, further comprising verifying an identity of the customer based on an authentication received from the customer.

20. A method, comprising:
identifying out of pattern login behavior on a customer account, wherein the out of pattern behavior comprises one or more interactions wherein at least one of an Internet protocol address, a device identification, or a location associated with the one or more interactions that does not match past interactions;
determining that at least one of fraud or unauthorized money movement has occurred in the customer account;
automatically logging into the customer account with incorrect credentials a sufficient number of times to trigger a lockout from the customer account;
receiving, at a financial institution associated with the customer account, at least one form of authentication from a customer associated with the customer account to verify an identity of the customer; and
directing the customer to change login credentials on the customer account.
